(19) United States
(12) Patent Application Publication
(10) Pub. No.: US 2005/0274445 A1
(43) Pub. Date: Dec. 15, 2005

(54) Method for manufacturing decoration of imitation metal

(76) Inventor: Paul Chang, Hsichih City (TW)

Correspondence Address: LEONG C LEI, PMB # 1008, 1867 YGNACIO VALLEY ROAD, WALNUT CREEK, CA, 94598, US

(21) Appl. No.: 10/856,880

(22) Filed: Jun. 1, 2004

(51) Int. Cl. A44C 25/00; B44C 1/00; B05D 5/12; B65D 17/00

(52) U.S. Cl. 156/63; 63/34; 427/124

(57) ABSTRACT

The invention discloses a method for manufacturing a decoration of imitation metal, including the steps of making a blank element with a plastic material; conducting vacuum electro-plating to the blank element in order to form a metal-like color; applying a layer of glass varnish on the electro-plated blank of a metal-like color to form a semi-product; and inlaying jewelry into the semi-production applied with a glass varnish to accomplish a decoration appearing to be made of a metallic material.

### BACKGROUND OF THE INVENTION

(a) Technical Field of the Invention

The present invention relates to a method for manufacturing a decoration of imitation metal, particularly to a decoration appearing to be made of a metallic material. Substantially the decoration is made of PVC, such that the manufacture cost and the weight of the decoration can be efficiently reduced.

(b) Description of the Prior Art

Generally, decorations inlayed with jewelry are made of metal, so that the jewelry pellets can be firmly held in the metal. The metal material can be processed by a conventional press process, which, however, produces unnecessary waste material from the processed boards and therefore required subsequent treatment and management, such as recycle of the waster material, rendering additional issues and costs. Although the issue in respect of costs can be overcome by powder metallurgy, there still exists the common issues of overweight in decorations made of metal, rendering the clothing wearing the decoration sinking and transforming.

Provided the decorations can be made of a lighter material as plastic, the above-mentioned issues of costs, weight and waste material, etc. can be efficiently solved.

Fearing that the surface of the plastic decoration might not fit the imitated jewelry, there is a need to process with colorants on the surface of the plastic blank such that the accomplished decoration may have the color and luster appearing as a real metal article.

Considering the disadvantages existing in the metal decorations and plastic decorations made according to the prior arts, the inventor has researched and developed the improvements as disclosed in the invention.

### SUMMARY OF THE INVENTION

The primary object of the invention is to provide an effect that makes a piece of decoration inlayed with jewelry but made of plastic material appear like a metal article. Meanwhile, the costs of manufacture and weight of the decoration can be efficiently reduced.

To obtain the above objects, the invention discloses a method for manufacturing a decoration of imitation metal, including the following steps:
(a) making a blank element with a plastic material, which is preferably PVC, such that after a blank is formed to be a base material, the surface of the blank would appear an appropriate roughness and plain color for further process;
(b) conducting vacuum electroplating to the blank element in order to form a metal-like color on the surface thereof, such as golden yellow color to appear like gold, or light gray to appear like platinum, etc.;
(c) applying a layer of glass varnish, which can serve as a protection for the electro-plating layer from scratch, on the electroplated blank of a metal-like color to form a semi-product; and
(d) inlaying jewelry into the semi-production applied with a glass varnish to accomplish a decoration appearing a metal material.

By way of the above steps, the declaration can have the effect as a metal article inlayed with jewelry, and the quality and value of the production are greatly enhanced.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view of the blank element according to the present invention.

FIG. 2 shows the process of vacuum electroplating of the blank element.

FIG. 3 shows the application of a glass varnish to the well electro-plated blank element.

FIG. 4 shows the blank element inlayed with jewelry and diamonds. FIG. 5 is a flow chart showing the manufacturing steps according to the invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

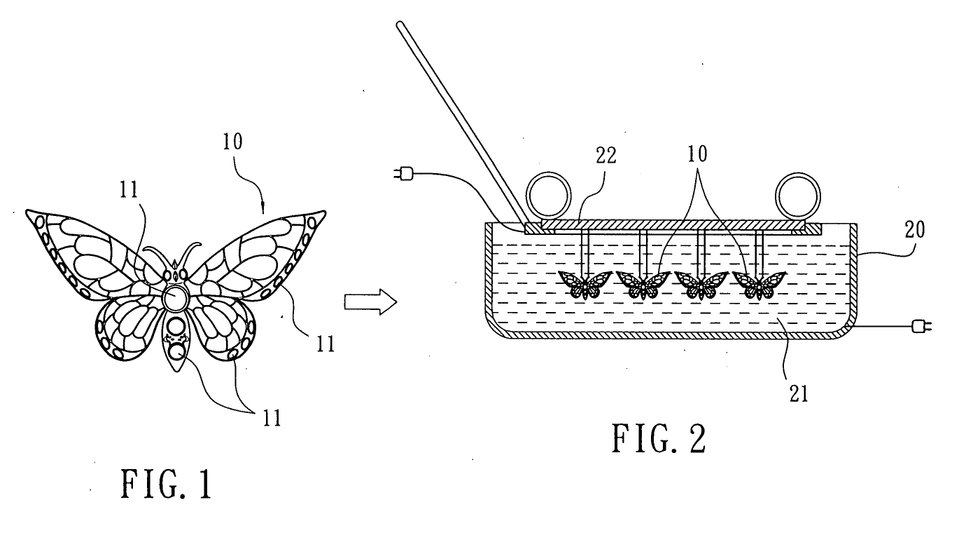

Referring to FIGS. 1 to 5, the invention discloses a method for manufacturing a decoration of imitation metal. The process primarily includes the following steps: (a) making a blank element with a plastic material, (b) vacuum electroplating, (c) applying glass varnish, and (d) inlaying jewelry. Accordingly, the decoration made of plastic can appear elegance like a metal product.

Hereafter are the detailed steps of the invention:

(a) Making a blank element with a plastic material: The blank can be made by manually modeling, or alternatively by injecting a melted plastic material, such as PVC, into a mold, to obtain a blank element 10 (as shown in FIG. 1) having pluralities of recessions 11 on the surface. While the blank element 10 shown is a specific pattern (butterfly) formed integrally, the other embodiments of various patterns can be made accordingly. Furthermore, pluralities blanks can be made and assembled to accomplish a complicatedly designed product (not shown).

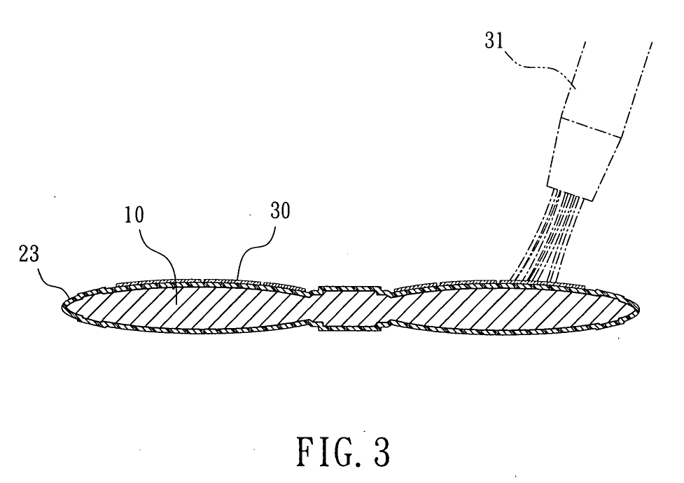

(b) Vacuum electro-plating: As shown in FIG. 2, an electro-plating bath 20 containing electroplating solution 21 is provided. Pluralities of blank elements 10 are held and suspended by a hanging plate 22, such that each of the blank element 10 can immerse in the electro-plating solution 21. After the electroplating bath 20 and the hanging plate 22 are conducted with power of different electrodes, the blank elements 10 will be coated with a electro-plating layer 23.

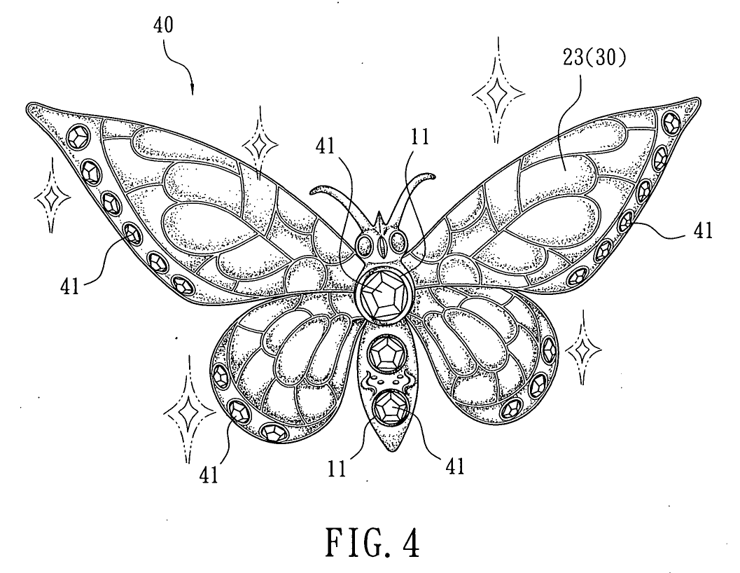

(c) Applying glass varnish: As shown in FIG. 3, a brush 31 moistened with glass varnish 30 is brushed on the surface of the electro-plating layer 23, such that the electroplating layer 23 is completely covered by a layer of glass varnish 30 for enhancing the hardness of the surface of the decoration, retaining a fresh and gloss character, and refraining from being worn easily.

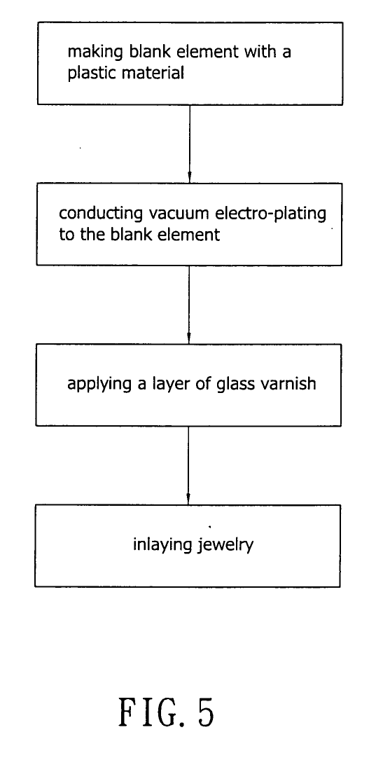

(d) Inlaying jewelry: As shown in FIG. 4, while pluralities of recessions 11 have been provided on the blank element 10, imitation jewelry and diamonds 41 can be inlayed into the recessions 11. The electro-plating layer 23 and glass varnish layer 30 on the board surfaces not inlayed with jewelry or diamonds would represent the metal color and lust and a glittering-and-translucent effect. Accordingly, the decoration 40 is accomplished.

Concluded above, the invention relates to a method for manufacturing a decoration by plastic material but to obtain an effect of almost real metal. The advantages of the invention are that the decoration can be mass-produced to reduce costs, and that the decoration being light and handy is easy for collocation with clothing.

While certain novel features of this invention have been shown and described and are pointed out in the annexed Claims, it is not intended to be limited to the details above, since it will be understood that various omissions, modifications, substitutions and changes in the forms and details of the device illustrated and in its operation can be made by those skilled in the art without departing in any way from the spirit of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A method for manufacturing a decoration of imitation metal, including the following steps:
(a) making a blank element with plastic material;
(b) conducting vacuum electro-plating to the blank element in order to form a metal-like color;
(c) applying a layer of glass varnish on the electro-plated blank of a metal-like color to form a semi-product; and
(d) inlaying jewelry into the semi-production applied with a layer of glass varnish to accomplish a decoration appearing to be a metal material.

2. The method for manufacturing a decoration of imitation metal according to claim 1, wherein the plastic material is PVC.

3. The method for manufacturing a decoration of imitation metal according to claim 1, wherein the blank element is a single board integrally formed as a decoration.

4. The method for manufacturing a decoration of imitation metal according to claim 1, wherein the blank element is composed by pluralities of boards to form a decoration.

5. The method for manufacturing a decoration of imitation metal according to claim 1, wherein electroplating material can be copper.

6. The method for manufacturing a decoration of imitation metal according to claim 1, wherein the blank element is made of manually modeling.

7. The method for manufacturing a decoration of imitation metal according to claim 1, wherein the blank element is made by a mold with injection processing.
